(19) United States
(12) Patent Application Publication
(10) Pub. No.: US 2008/0140753 A1
(43) Pub. Date: Jun. 12, 2008

(54) Multiplier

(76) Inventors: Vinodh Gopal, Westboro, MA (US); Gilbert M. Wolrich, Framingham, MA (US); Wajdi Feghali, Boston, MA (US); Robert P. Ottavi, Brookline, NH (US)

Correspondence Address: INTEL/BLAKELY, 1279 OAKMEAD PARKWAY, SUNNYVALE, CA, 94085-4040, US

(21) Appl. No.: 11/636,016

(22) Filed: Dec. 8, 2006

(51) Int. Cl. G06F 17/00

(52) U.S. Cl. 708/523

(57) ABSTRACT

An electronically implemented method includes multiplying a number A, and a number B, where A is composed of segments aᵢ and B is composed of segments bⱼ where i and j are integers greater than 1. The multiplying includes determining partial product values for at least some of aᵢbⱼ and determining a sum of partial product values for aᵢbⱼ and aⱼbᵢ where aᵢ=bⱼ and bⱼ=aᵢ for respective values of i and j, by multiplying one of (1) aᵢbⱼ and (2) aⱼbᵢ by two. A sum is determined and stored in a memory storage element of the determined partial product values and the determined sum of partial product values for aᵢbⱼ and aⱼbᵢ.

### REFERENCE TO RELATED APPLICATIONS

This application relates to pending U.S. application Ser. No. 11/323,994, entitled “Multiplier”, filed Dec. 30, 2005.

This application relates to pending U.S. application Ser. No. 11/323,993, entitled “Cryptographic Processing Units and Multiplier”, filed Dec. 30, 2005.

### BACKGROUND

Cryptography protects data from unwanted access. Cryptography typically involves mathematical operations on data (encryption) that makes the original data (plaintext) unintelligible (ciphertext). Reverse mathematical operations (decryption) restore the original data from the ciphertext. Cryptography covers a wide variety of applications beyond encrypting and decrypting data. For example, cryptography is often used in authentication (i.e., reliably determining the identity of a communicating agent), the generation of digital signatures, and so forth.

Current cryptographic techniques rely heavily on intensive mathematical operations. For example, many schemes use a type of modular arithmetic known as modular exponentiation which involves raising a large number to some power and reducing it with respect to a modulus (i.e., the remainder when divided by given modulus). Mathematically, modular exponentiation can be expressed as g^{e} mod M where e is the exponent and M the modulus.

Conceptually, multiplication and modular reduction are straight-forward operations. However, often the sizes of the numbers used in these systems are very large. For example, the “e” in ge may be hundreds or even thousands of bits long. Performing operations on such large numbers may be very expensive in terms of time and in terms of computational resources.

### BRIEF DESCRIPTION OF THE DRAWINGS

FIG. 1 is a diagram of a multiplier.

FIG. 2 is a diagram illustrating partial products determined by the multiplier.

FIG. 3 is a diagram illustrating partial products determined by parallel multipliers.

FIG. 4 is a diagram of a component featuring multiple processing units coupled to a multiplier.

### DETAILED DESCRIPTION

A wide variety of cryptographic operations rely on multiplication. For example, modular exponentiation (e.g., determining g^{e} mod M) is at the heart of a variety of cryptographic algorithms such as RSA (a cryptography algorithm named for Rivest, Shamir, and Adelman) and Diffie-Helman. For instance, in RSA, a public key is formed by a public exponent, e-public, and a modulus, M. A private key is formed by a private exponent, e-private, and the modulus M. To encrypt a message (e.g., a packet or packet payload) the following operation is performed:

ciphertext=cleartext^{e-public} mod M

To decrypt a message, the following operation is performed:

cleartext=ciphertext^{e-private} mod M.

### The cleartext, ciphertext, and public and private exponents may be very large numbers making these operations computationally expensive.

A common approach for performing modular exponentiation processes the bits in exponent e in a sequence, for example, from left to right. For each “0” bit in the exponent string, the procedure squares the current result. For each “1” bit, the procedure both squares and multiplies by g. Modular reduction may be performed at the end when a very large number may have been accumulated or modular reduction may be interleaved within the multiplication operations such as after processing every exponent bit or every few exponent bits. In this sample approach, while some fraction of the exponent bits cause a non-squaring multiplication, run-time is dominated by the squaring operations which occur for each bit.

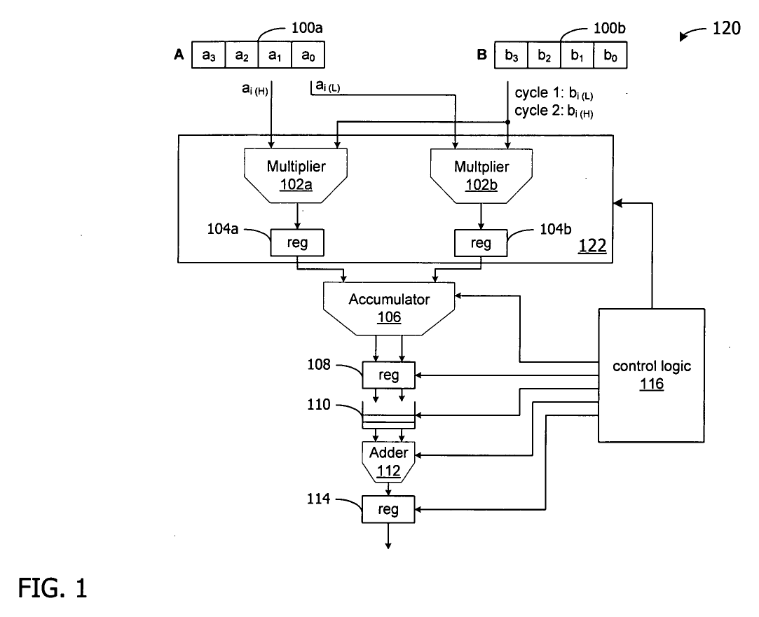

The sample modular exponentiation algorithm described above illustrates that the performance of cryptography implementations may rely heavily on the efficiency of multiplication, squaring operations in particular. FIG. 1 illustrates a sample implementation of a multiplier 120 that is capable of high performance at modest clock speeds and is very area-efficient. Various modular exponentiation algorithms of large numbers can be implemented very efficiently using the multiplier 120. In addition to efficiently handling general operand multiplication, the multiplier 120 includes logic to enhance the performance of squaring operations, potentially, reducing the number of clock cycles used to perform squaring and reducing power beyond the reduction in clock cycles.

As shown in FIG. 1, the multiplier 120 operates on two operands A 100a and B 100b. FIG. 1 shows operands A 100a and B 100b as composed of sets of segments aᵢ and bⱼ. For regularly sized segments, the operands can be expressed as

$${\sum }_{i = n}^{0} {a}_{i} {x}^{i} and {\sum }_{i = n}^{0} {b}_{j} {x}^{i} .$$

For example, in the sample illustrated in FIG. 1 where n=3, A=a₃x³+a₂x²+a₁x¹+a₀ and B=b₃x³+b₂x²+b₁x¹+b₀. The width of aᵢ and bⱼ (e.g., the value of x) may be selected based on the widths of A 100a and B 100b and the datapath size of the following multiplier 120 components. For example, for a 512-bit A 100a and B 100b, x may be set to 2¹²⁸ yielding uniform 128-bit sized segments.

The values of A 100a and B 100b may be stored in respective FIFO (First-In-First-Out) queues that buffer the operands 100a, 100b. The width of the FIFOs may vary. For example, a 512-bit number may be stored in 8 64-bit FIFO entries. The number of entries in each FIFO may vary. For example, a given FIFO may feature sufficient entries to buffer multiple operands of multiple multiplication problems. For instance, a FIFO may have 16 64-bit entries so that two full sets of operands for two complete multiplication problems can be queued at a time. The number of operands that can be queued is a tradeoff between area (due to larger area for more entries) and performance. As described below, the multiplier 120 can simultaneously operate on multiple multiplication problems, thus the ability to enqueue multiple operands can increase performance.

As shown, the multiplier 120 can operate as a pipeline that feeds intermediate results through multiplier 120 components under the control of control logic 116. The multiplier 120 can perform a multiplication operation by computing a partial product for each combination of segments aᵢbⱼ. Assuming 512-bit A 100a and B 100b operands segmented into 128-bit aᵢ and bⱼ segments, the multiplier 120 can compute A×B by summing the 16 partial products of aᵢbⱼ.

To determine partial products, the multiplier 120 features a set (e.g., two) of multipliers 102a, 102b that operate in parallel. The multpliers 102a, 102b may be N×N unsigned integer multipliers (e.g., 64×64-bit multipliers) where N may be configured based on the expected size of the operands. The N×N multipliers 102a, 102b may be a conventional array multipliers. As shown, the multipliers 102a, 102b can be carry-sum multipliers that output a vector that represents the results absent any carries to more significant bit positions and a vector that stores the carries. Addition of the two vectors can be postponed until the final results are needed. The carry/sum architecture helps reduce the area consumed by multiplier 120 by not requiring a large carry-propagate adder in the front-end of the multiplier 120, though a carry-propagate architecture may alternately be implemented. As shown, in FIG. 1, an adder 112 combines both carry and sum vectors to generate final multiplication results.

The multipliers 102a, 102b determine a partial product for aᵢbⱼ by, respectively, determining a_{i(H)}b_{j(L)} and a_{i(L)}b_{j(L)} in a first cycle and determining a_{i(H)}b_{j(H)} and a_{i(L)}b_{j(H)} in a second cycle where the (H) and (L) notations indicate the (H)igh and (L)ow order bits of each respective segment. The multipliers 102a, 102b output the partial products into registers 104a, 104b. The partial products are shifted based on the significance of the respective aᵢ and bⱼ segments.

The output of registers 104a, 104b is fed into an accumulator 106 which adds the partial products to any previously stored partial product results. Potentially, the register 104a, 104b output may occur each cycle. In other implementations, the registers 104a, 104b may be replaced with accumulators and output to the accumulator 106 every two-cycles. Again, the accumulator 106 may operate in carry/sum form. Returning to the 512-bit example describe above, assuming 2-cycles per partial product, the multiplier 120 uses 32-cycles to compute each of the 16 partial products using multipliers 102a, 102b. In such a configuration, the accumulator 106 may be 260-bits in width (e.g., 256-bits+4-bits to account for intermediate products that may exceed 256-bits).

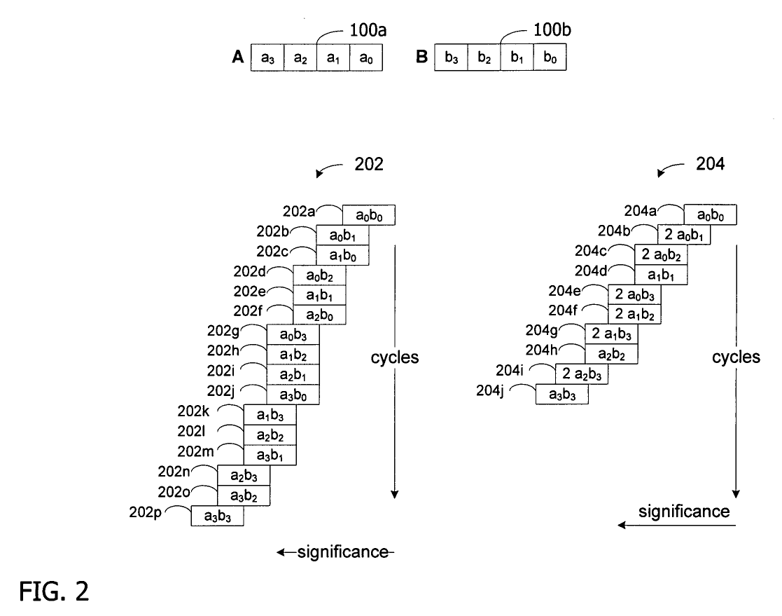

The order of computation of the partial products can be sequenced to output least-significant bits of the final result as they are ready. For example, (as shown in FIG. 2 described below) the partial products may be computed in increasing order of result significance. When a set of least-significant bits is stored by the accumulator 106 such that subsequent partial product computation will not affect the set of bits, the accumulator 106 shifts out the set of bits to a FIFO 110 via register 108. For example, after computing a₀b₀, the lower bits (e.g., the lower 128-bits in the running 512-bit example) can be shifted out of accumulator 106 for enqueuing in FIFO 110. The accumulator 106 generally does not retire bits with each partial product computation since multiple partial products may overlap the same bits of the final result. When an accumulator 106 retires bits, the shifting of the accumulator 106 adjusts the significance of the values stored in accumulator 106 and the control logic 116 correspondingly adjusts the shifting of partial products fed into the accumulator 106 by the multipliers 102a, 102b. The final partial product causes the accumulator 106 to retire a burst of bits emptying the accumulator 106.

The FIFO 110 stores bits of the carry/save vectors retired by the accumulator 106. Potentially, the FIFO 110 may be implemented as a pair of FIFOs, one for the carry vector and one for the sum vector. The FIFO 110 in turn, feeds an adder 112 that sums the retired portions of carry/save vectors. The FIFO 110 can smooth feeding of bits to the adder 112 such that the adder 112 is continuously fed retired portions in each successive cycle until the final multiplier 120 result is output. Without FIFO 110, the adder 112 would stall when a cycle that does not result in retirement of accumulator 106 bits propagates down the pipeline. Instead, by filling the FIFO 110 with the retired bits and deferring dequeuing of FIFO 110, the FIFO 110 can ensure continuous operation of the adder 112. The FIFO 110 may be minimized to only to store a sufficient number of retired bits such that “skipped” retirement cycles do not stall the adder 110 subject to the constraint that the FIFO 110 should be large enough to accommodate the burst of retired bits in the final cycles. For example, in the running example, a 4-entry 256-bit FIFO 110 is sufficient to ensure that adder 112 is active once FIFO 110 dequeuing begins, assuming a 64-bit adder 112.

The adder 112 output is fed to register 114 for aggregation into the final product. For example, the register 114 may feed a FIFO (not shown) or other electronic storage element (e.g., register or memory location) that enqueues the final product bits for receipt by a destination of the multiplication results.

Due to the pipeline architecture, the multiplier 120 can start working on a new problem when it has finished a previous problem and a sufficient portion of the operands have been enqueued. That is, work on a new multiplication problem may begin before the adder 112 has completed work on a previous problem. To facilitate this, the multiplier enqueues the least-significant-words of the operands first and work on the new problem can potentially begin before the entire operands for a problem have been enqueued.

Operation of the multiplier 120 proceeds under the control of control logic 116. The logic 116 controls, among other operations, which operand segments are supplied to multipliers 102a, 102b, the shifting of partial products in registers 104a, 104b, retirement of bits from accumulator 106, and the queuing/dequeuing of FIFO 110. As described below, this control logic 116 can be optimized to enhance the performance of squaring operations.

FIG. 2 illustrates operation of the multiplier in both multiplication 202 and squaring 204 modes. As shown in FIG. 2, in multiplication mode 202, each term of A 100a is multiplied by each term of B 100b and the resulting partial product is shifted based on the significance of the terms within their operand. As shown, the operations are sequenced 202a-202p such that the least significant values of the final multiplication result can be determined first. In the sample sequence 202a-202p, assuming two-cycles per partial product computation, computing the set of partial products 202a-202p consumes 32-cycles partial product values.

If, however, A=B, the multiplier 120 can reduce the number of partial products determined. That is, if A=B, it follows that aᵢbⱼ=aⱼbᵢ. Thus, only one of aᵢbⱼ or aⱼbᵢ needs to be computed and doubled instead of computing both aᵢbⱼ and aⱼbᵢ. Thus, as shown in FIG. 2, if A=B, a sequence 204 can perform a single partial product determination for two that appeared in the more general multiplication sequence 202. For example, instead of computing both a₀b₁ 202b and a₁b₀ 202c, sequence 204 need only compute and shift (multiply by 2) a₀b₁ 204b. Similarly, instead of computing both a₀b₂ 202d and a₂b₀ 202f, sequence 204 need only compute and shift a₀b₂ 202c. As shown, this optimization reduces the number of partial product computations in this example from 16 202a-202p to 10 204a-204j. Again, assuming 2-cycles per partial product computation, this nets a 12-cycle speed increase and commensurate reduction in power and heat associated with each operand 100a, 100b multiplication.

Benefits of the approach illustrated above may apply even when A 100a and B 100b are not equal. For example, control logic 116 may take advantage of the approach above whenever aᵢbⱼ=aⱼbᵢ (e.g., when aᵢ=aⱼ and bᵢ=bⱼ or when aᵢ=bⱼ and aⱼ=bᵢ). These comparisons of segments may make such optimizations unattractive depending on the relative cost of compare operations with multiplication operations.

As shown, the multiplier 120 can select a mode of operation depending on whether A=B. For example, the multiplier 120 may make an initial compare operation of the operands. For example, the multiplier 120 may XOR A 100a and B 100b and may respond to a zero result by selecting “squaring” mode. However, this approach requires the entire operand to be loaded before beginning computations. Thus, the multiplier 120 may instead receive a signal specifying that A=B or that a squaring operation of either A 102a or B 102b should occur regardless of the value of the other operand. For example, a programmable processing element using the multiplier 120 may feature an instruction that specifies a squaring operation. The processing element may in turn send a squaring signal or message to the multiplier 120 in response to the instruction execution. Potentially, the A 102a and B 102b numbers may refer to the same set of storage locations (e.g., address of A=address of B or in other words B is A).

The techniques illustrated in FIG. 2 can be implemented by the control logic 116 of the multiplier 120 illustrated in FIG. 1. For example, in multiplication mode for two 512-bit numbers, the control logic 116 may coordinate the multiplier 120 to compute the partial products as shown in sequence 202. A 128-bit least significant word is shifted out of the accumulator 106 and into the FIFO 110 at cycles {2, 6, 12, 20, 26, 30}. At cycle 32, 2 128-bit quadwords are shifted into the FIFO 110. After an initial wait, the adder 112 retires one 64-bit result word per cycle until the full 1024-bit result has been written output in a continuous burst of 16-cycles. The adder starts at cycle-20, and at each cycle thereafter retires the 128-bit (Sum/Carry) word-pair at the head of the FIFO 110 in redundant form with a full carry propagation. The adder 112 outputs the results to register 114. The throughput in the multiply-mode is limited by the generation of partial products that consumes 32 cycles; thus a new multiply problem can be streamed in every 32 cycles.

In squaring mode, the control logic 116 selects a different sequence 204 of partial product computations. In particular, the control logic 116 can determine how to handle a partial product by a comparison of the i and j indices. That is, if i does not equal j, the control logic 116 shifts the multiplier block output of aᵢbⱼ fed into the accumulator 106 by one bit and skips subsequent computation of aⱼbᵢ. If i equals j, no such shifting occurs.

In contrast to general multiplication, in the running example, the control logic 116 causes a 128-bit least significant quad-word to be shifted out into the FIFO 110 at cycles {2, 4, 8, 12, 16, 18}. At cycle 20, 2 128-bit quadwords are written into the FIFO 110 in a burst. The adder 112 starts at cycle-8 and transfers the final results in a continuous burst of 16-cycles. The throughput is still limited by partial-product generation; though this is reduced, e.g., to 20-cycles.

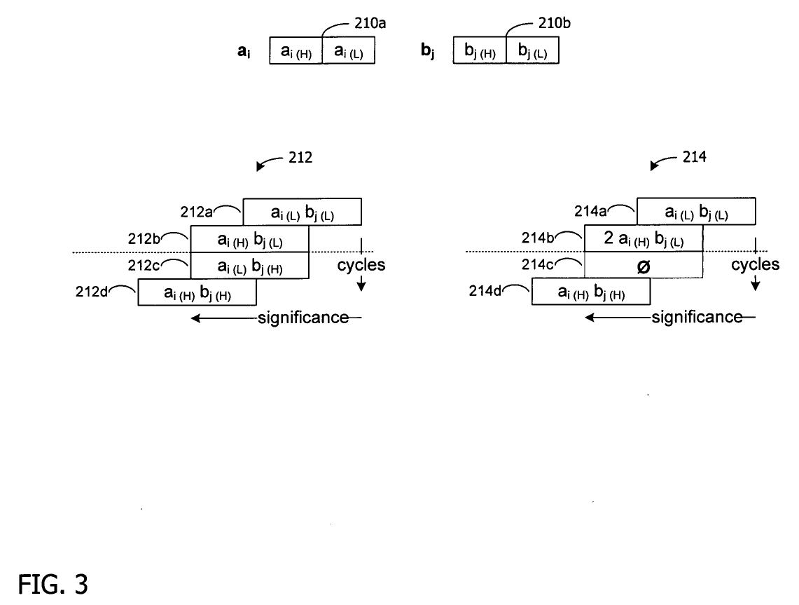

FIG. 3 illustrates operation 212 of multipliers 102a, 102b operating on operands aᵢ 210a and bⱼ 210b. As shown, aᵢ 210a and bⱼ 210b are composed of high and low significance sub-segments—aᵢ 210a is formed by sub-segments a_{I(H)} and a_{i(L)} while bⱼ 210b is formed by sub-segments b_{j(H)} and b_{j(L)}. In a sample implementation of the multiplier 120 shown in FIG. 1 where aᵢ 210a and bⱼ 210b may both be 128-bits and multiplier blocks 102a, 102b are 64×64 multipliers, sub-segments a_{i(H)}, a_{i(L)}, b_{j(H)}, and b_{j(L)} may be 64-bits in length.

As shown in FIG. 3, the multipliers 102a, 102b can use two cycles to compute each combination of a_{i(H)}, a_{i(L)}, b_{j(H)}, and b_{j(L)}. For example, multiplier 102a may compute a_{i(L)} b_{j(L)} 212a while multiplier 102b simultaneously computes a_{i(H)} b_{j(L)} 212b in a following cycle, multipliers 102a and 102b can simultaneously compute a_{i(L)} b_{j(H)} 212c and a_{i(H)} b_{j(H)} 212d respectively.

However, as shown in FIG. 3, when aᵢ=bⱼ, fewer partial product multiplications may be needed. That is, when aᵢ=bⱼ, a_{i(H)} b_{j(L)}=a_{i(L)} b_{j(H)}. Thus, as shown in FIG. 3, when aᵢ=bⱼ, the a_{i(H)} b_{j(L)} term can be computed 214b and shifted (e.g., multiplied by 2) to provide the partial products of both a_{i(H)} b_{j(L)}, and a_{i(L)} b_{j(H)}. As a result, one of the multiplier blocks 102b can be powered down 214c (indicated by the “ø” operation) since it is not needed in this situation. In the sample shown, powering down a multiplier 102a or 102b can net a 25% reduction in power for the partial product computation which in turn can reduce heat generated. Powering down a multiplication block 102a, 102b can be performed in a variety of ways. For example, the clock input may be AND-ed with an enable bit output by control logic 116.

More generally, the above optimization can work when a_{i(H)}=b_{j(L)} and a_{i(L)} b_{j(L)} even if aᵢ and bⱼ are not equal. Such an implementation would effectively replace mutliplier 102a, 102b cycles with compare operations which may only be desirable based on the relative time and power expense of these operations.

Techniques described can be implemented in variety of ways and in a variety of systems. For example, instead of the multiplier 120 architecture depicted in FIG. 1, the techniques may be implemented in other dedicated digital or analog hardware (e.g., determined by programming techniques described above in a hardware description language such as Verilog™), firmware, and/or as an ASIC (Application Specific Integrated Circuit) or Programmble Gate Array (PGA). The techniques may also be implemented as computer programs, disposed on a computer readable storage medium, for processor execution. For example, the processor may be a general purpose processor.

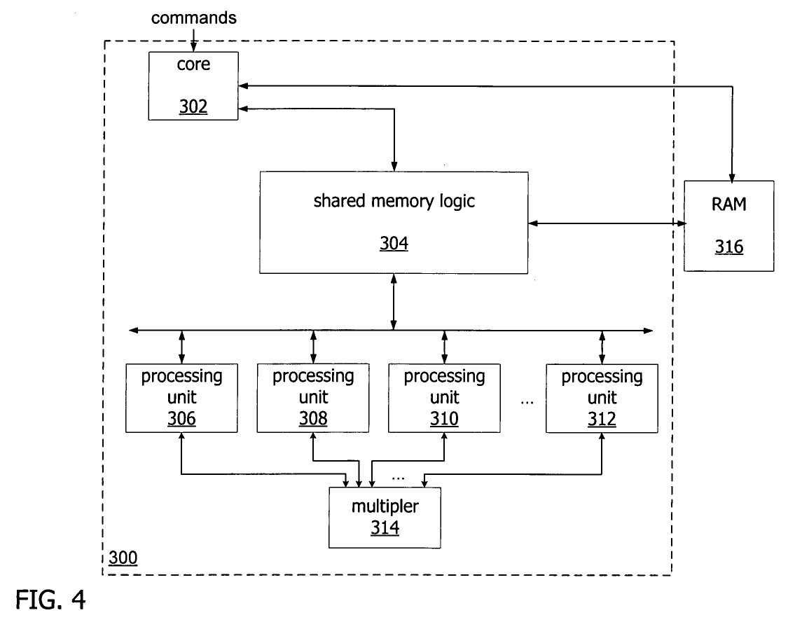

As shown in FIG. 4, the techniques may be implemented by computer programs executed by a processor module 300 that can off-load cryptographic operations. As shown, the module 300 includes multiple programmable processing units 306-312 and a dedicated hardware multiplier 314. The processing units 306-312 run programs on data downloaded from shared memory logic 304 as directed by a core 302. Other processors and/or processor cores may issue commands to the module 300 specifying data and operations to perform. For example, a processor core may issue a command to the module 300 to perform modular exponentiation on g, e, and M value stored in RAM 316. The core 302 may respond by issuing instructions to shared memory logic 304 to download a modular exponentiation program to a processing unit 306-312 and download the data being operated on from RAM 316, to shared memory 304, and finally to processing unit 306-312. The processing unit 306-312, in turn, executes the program instructions. In particular, the processing unit 306-312 may use the multiplier 316 to perform multiplications or squaring-s of operands determined by the program instructions. Upon completion, the processing unit 306-312 can return the results to shared memory logic 304 for transfer to the requesting core. The processor module 300 may be integrated on the same die as programmable cores or on a different die.

As shown, the multiplier 314 is connected to multiple processing units 306-312 that permits each unit 306-312 to dispatch operands to the multiplier 314 and await a response. Use of the multiplier 314 by the units 306-312 may be arbitrated in a variety of ways. For example, the multiplier 314 may round-robin among units for each set of operands. Alternately, the multiplier 314 may service all pending multiplication problems enqueued by a single unit before servicing another unit 306-312. Again, a wide variety of alternate schemes maybe implemented.

FIG. 4 merely illustrates a sample architecture for using the multiplication techniques described above. The techniques, however, can be used in a wide variety of other architectures such as with a programmed traditional general purpose processor, network interface card, network processor, graphics card, network storage device, and so forth.

The term circuitry as used herein includes hardwired circuitry, digital circuitry, analog circuitry, programmable circuitry, and so forth. The programmable circuitry may operate on computer programs.

Other embodiments are within the scope of the following claims.

What is claimed is:

1. An electronically implemented method, comprising:
multiplying a number A, and a number B, where A is composed of segments aᵢ and B is composed of segments bⱼ where i and j are integers greater than 1, wherein the multiplying comprises:
determining partial product values for at least some of aᵢbⱼ;
determining a sum of partial product values for aᵢbⱼ and aⱼbᵢ where aᵢ=bⱼ and bⱼ=aᵢ for respective values of i and j, by multiplying one of (1) aᵢbⱼ and (2) aⱼbᵢ by two;
determining a sum of the determined partial product values and the determined sum of partial product values for aᵢbⱼ and aⱼbᵢ; and
storing the sum of the determined partial product values and the determined sum of partial product values for aᵢbⱼ and aⱼbᵢ in a memory storage element.

2. The method of claim 1, further comprising:
receiving an indication that A=B.

3. The method of claim 1, further comprising:
determining if i=j for respective values of i and j.

4. The method of claim 1, wherein the multiplying of the number A and the number B comprises a multiplying performed as a set of operations to exponentiate a number, x, by an exponent, e, as a part of a cryptographic operation on a message.

5. The method of claim 1, wherein the electronically implemented method comprises a method implemented by a multiplier comprising multiple multipliers arranged in parallel, at least some of the multiple multipliers to simultaneously determine a partial product.

6. The method of claim 5, wherein the multiplier comprises a pipeline including the multiple multipliers, an accumulator to receive output of the multiple multipliers, a queue to buffer accumulator output, and an adder fed by the queue.

7. The method of claim 1, wherein determining aᵢbⱼ, for aᵢ=bⱼ comprises determining a_{i(H)}b_{j(H)}, a_{i(L)}b_{i(L)}, and only one of a_{i(H)}b_{j(L)} and a_{i(L)}b_{j(H)}.

8. The method of claim 1, wherein the multiplying of the number A and the number B comprises a squaring of the first number A.

9. The method of claim 1, wherein for one of aᵢbⱼ and aⱼbᵢ where aᵢ=bⱼ and bⱼ=aᵢ for respective values of i and j, one of aᵢbⱼ and aⱼbᵢ is not computed.

10. An apparatus to multiply a number A, and a number B, where A is composed of segments aᵢ and B is composed of segments bⱼ where i and j are integers greater than 1, the apparatus comprising logic to:
determine partial product values for at least some of aᵢbⱼ;
determine a sum of partial product values for aᵢbⱼ and aⱼbᵢ where aᵢ=bⱼ and bⱼ=aᵢ for respective values of i and j, by multiplying one of (1) aᵢbⱼ and (2) aⱼbᵢ by two;
determine a sum of the determined partial product values and the determined sum of partial product values for aᵢbⱼ and aⱼbᵢ; and
store the sum of the determined partial product values and the determined sum of partial product values for aᵢbⱼ and aⱼbᵢ in a memory storage element.

11. The apparatus of claim 10, further comprising logic to receive an indication that A=B.

12. The apparatus of claim 10, wherein the apparatus comprises multiple multipliers arranged in parallel, at least some of the multiple multipliers to simultaneously determine a partial product of aᵢbⱼ.

13. The apparatus of claim 12, wherein the multiplier comprises a pipeline including the multiple multipliers, an accumulator to receive output of the multiple multipliers, a queue to buffer accumulator output, and an adder fed by the queue.

14. The apparatus of claim 10, wherein determining aᵢbⱼ, for aᵢ=bⱼ comprises determining a_{i(H)}b_{j(H)}, a_{i(L)}b_{i(L)}, and only one of a_{i(H)}b_{j(L)} and a_{i(L)}b_{j(H)}.

15. The apparatus of claim 12, wherein determining aᵢbⱼ, for aᵢ=bⱼ comprises determining a_{i(H)}b_{j(H)}, a_{i(L)}b_{i(L)}, and only one of a_{i(H)}b_{j(L)} and a_{i(L)}b_{j(H)}.

16. The apparatus of claim 10, wherein the multiplying comprises a squaring of the number A.

17. The apparatus of claim 10, wherein for one of aᵢbⱼ and aⱼbᵢ where aᵢ=bⱼ and bⱼ=aᵢ for respective values of i and j, one of aᵢbⱼ and aⱼbᵢ is not computed.

18. The apparatus of claim 10, wherein the apparatus has at least two modes of multiplication, a first multiplication mode that computes each aᵢbⱼ partial product and a second squaring mode that computes fewer than each aᵢbⱼ partial product.

19. A computer program product, disposed on a computer readable storage medium, the program including instructions for causing squaring of a number A, where A is composed of segments aₓ and x is an integer greater than 1, wherein the multiplication comprises:
determining partial product values for at least some of aᵢaⱼ where i and j are integers;
determining a sum of partial product values for aᵢaⱼ and aⱼaᵢ where aᵢ=aⱼ and aⱼ=aᵢ for respective values of i and j, by multiplying one of (1) aᵢaⱼ and (2) aⱼaᵢ by two;
determining a sum of the determined partial product values and the determined sum of partial product values for aᵢaⱼ and aⱼaᵢ; and
storing the sum of the determined partial product values and the determined sum of partial product values for aᵢaⱼ and aⱼaᵢ in a memory storage element.

20. The computer program product of claim 19, wherein the multiplication further comprises determining if i=j for respective values of i and j.

21. The computer program product of claim 19, wherein computer program includes instructions to exponentiate a number.

22. The computer program product of claim 19, wherein determining aᵢaⱼ, for aᵢ=aⱼ comprises determining a_{i(H)}a_{j(H)}, a_{i(L)}a_{i(L)}, and only one of a_{i(H)}a_{j(L)} and a_{i(L)}a_{j(H)}.

24. The computer program product of claim 19, wherein for one of aᵢaⱼ and aⱼaᵢ where aᵢ=aⱼ and aⱼ=aᵢ for respective values of i and j, one of aᵢaⱼ and aⱼaᵢ is not computed.

25. The computer program product of claim 19, wherein the multiplying one of (1) aᵢaⱼ and (2) aⱼaᵢ by two comprises shifting one of (1) aᵢaⱼ and (2) aⱼaᵢ.
